(19) United States
(12) Patent Application Publication
(10) Pub. No.: US 2006/0167752 A1
(43) Pub. Date: Jul. 27, 2006

(54) Automated segmentation and yield management

(76) Inventors: Brian Alan Pozesky, Chicago, IL (US); Matthew Moog, Chicago, IL (US); John Joseph Kordas, Orland Park, IL (US)

Correspondence Address: WOODCOCK WASHBURN LLP, ONE LIBERTY PLACE, 46TH FLOOR, 1650 MARKET STREET, PHILADELPHIA, PA, 19103, US

(21) Appl. No.: 11/321,964

(22) Filed: Dec. 29, 2005

Related U.S. Application Data
(60) Provisional application No. 60/640,808, filed on Dec. 29, 2004.

(51) Int. Cl. G06Q 30/00

(52) U.S. Cl. 705/14

(57) ABSTRACT

Methods, systems and computer readable media for presenting an offer. In one such method, a consumer is assigned to one of a plurality of market segments, and a yield for a plurality of offers is determined based on the assigned market segment. An offer is then selected for presentation to the consumer based on the yield.

### CROSS-REFERENCE

This application claims benefit to U.S. Provisional Application No. 60/640,808, filed Dec. 29, 2004, the disclosure of which is incorporated herein by reference in its entirety.

### BACKGROUND

The presentation of offers for products and services can be accomplished in any number of ways. Postal mail and billboards historically have been used to present offers. More recently, text messages and the Internet have been used. The offers may also be used as a means for collecting information on possible purchasers of a product or service. In such systems consumers are presented with offers in the form of advertisements, forms, coupons or other types of solicitations to which they can respond.

A marketing entity may accept offers from multiple advertisers, and may present the offers on a third party web site, or may host a web site on which the offers are presented. Each advertiser may provide the marketing entity with a value, such as a commission or other type of remuneration, based on the offers that are accepted by consumers. Some offers may result in a large commission to the marketing entity (such as high-dollar-value offers that are typically redeemed infrequently), or may result in smaller commissions (such as offers that are lower in value but are typically redeemed frequently). The commission received by the marketing entity may depend on the number of acceptances received for a particular offer, or on other considerations. Likewise, the advertisers typically receive some benefit from the acceptance of offers, such as a consumer purchase of their goods or services or the receipt of information from the consumer. As noted above, the commission is not limited to monetary compensation, as any type of value may be used in connection with an embodiment.

Thus, it is desirable for marketing entities to select offers to present to consumers based on the revenue the offers will generate for the marketing entity. For example, a combination of factors such as number of expected acceptances and commission to be received for each offer may be used to determine which offers to present more often. Conventionally, marketing entities use different methods to prioritize offers based on expected commissions, and typically present offers to consumers according to such prioritizations.

It is also desirable to tailor the offers to be presented to consumers so the offers have the greatest chance of being accepted. Otherwise, a consumer may be presented with an offer that is inappropriate, unusable, or for which the consumer is ineligible. Conventionally, a database of consumer characteristics is maintained, and when a particular consumer is to be presented with an offer, the characteristics are analyzed to determine the offer that is most likely to be accepted by the consumer.

Conventional systems, however, lack the ability to select offers that will maximize revenue for the advertiser and/or marketing entity while simultaneously being targeted to the characteristics of a consumer. For example, conventional tailoring systems lack a comprehensive ability to perform a revenue maximizing method on offers that are selected according to a market segment to which the consumer has been assigned, based on the consumer's characteristics. Thus, what is needed is a system and method for tailoring offers according to a consumer's characteristics while also selecting and presenting the tailored offers that are determined to maximize revenue for the advertiser and/or marketing entity based on those characteristics.

### SUMMARY OF THE INVENTION

In view of the above shortcomings and drawbacks, methods, systems and computer readable media for presenting an offer is disclosed herein. In one such method, a consumer is assigned to one of a plurality of market segments, and a yield for a plurality of offers is determined based on the assigned market segment. An offer is then selected for presentation to the consumer based on the yield.

### BRIEF DESCRIPTION OF THE DRAWINGS

FIG. 1 is a diagram illustrating an example environment in which offers are electronically presented;

FIG. 2 is a diagram illustrating an example environment in which aspects of the invention may be implemented;

FIG. 3A is a flowchart illustrating a method of performing market segmentation and yield management according to an embodiment of the invention;

FIG. 3B is a flowchart illustrating a method of performing yield management according to an embodiment of the invention;

FIG. 4A is a diagram illustrating an example of consumer characteristics that may be used in connection with an embodiment of the invention;

FIG. 4B is a diagram illustrating an example ranking of offers according to an embodiment of the invention; and

FIG. 5 is a diagram illustrating an example electronic interface in which aspects of the invention may be implemented.

### DETAILED DESCRIPTION OF ILLUSTRATIVE EMBODIMENTS

An embodiment of the invention relates to a system and method of providing offers to consumers. It will be appreciated that an “offer” may be any type of electronic marketing opportunity such as, for example, a web redirection, the presentation of an electronic form or coupon, a subscription offer, and the like. Accordingly, a consumer may “accept” an offer by any means appropriate to the offer type. For example, if the offer is a form, a consumer may accept the offer by filling out the form. In contrast, acceptance of a coupon offer may occur when a consumer selects the coupon for possible redemption, when the consumer actually redeems the coupon, or the like.

In addition, consumer acceptance of an offer may be defined by an agreement between parties who are responsible for presenting the offer to the consumer. For example, a product manufacturer may contract with a marketing entity to present the offer on a web site that is hosted by the entity. The term “presenter” is used herein to describe a marketing entity that presents offers from one or more advertisers to a consumer. The presenter may “brand” the web site so a consumer may not be able to tell that the web site is being presented by the presenter. The parties may, for example, agree that the presenter will be paid a commission by the manufacturer when a consumer selects the manufacturer's offer and provides personal information, such as an email address. The consumer may continue to provide additional information, or perform additional steps, after the offer has been “accepted” under such a definition.

For the sake of clarity, herein the term “advertiser” refers to an entity that provides the offer, such as for example a manufacturer, service provider, retailer or the like. The offer typically has a value to the advertiser, whether quantifiable or not. For example, the offer may be for the sale of a product or service, to acquire consumer information, or the like.

An offer may also have a value, such as a commission, that it returns to a presenter. As used herein, the term “value” refers to anything of worth that may be provided to any of the parties discussed herein. Examples of value may include, but are not limited to: monetary compensation, points, consumer referrals, etc. Offers that may be accepted a large number of times may individually result in a small per-acceptance value. Likewise, offers that may be accepted less often may have a larger per-acceptance value. Thus, the term “yield” is used herein to describe the frequency and time-adjusted value of an offer. For example, an offer that has a per-acceptance value of $1 that is typically accepted 10 times per day (i.e., the offer generates $10 per day) may have a lower yield than an offer that has a per-acceptance value of just $0.10 but is typically accepted 1,000 times per day (i.e., generates $100 per day). It should be appreciated that any time period may be used to calculate an offer's yield.

In addition, another type of measurement other than time may be used. For example, in one embodiment, a yield may be calculated based on a per-page impression value of the offer. It should be known that page impression refers to an instance of a particular offer being presented to a consumer in, for example, a web page. In such an embodiment, for example, an offer having a per-acceptance value of $1 may be accepted once every 100 page impressions, which results in an average yield of $0.01 per page impression. A second offer may, for example, have a per-acceptance value of $0.10 but is accepted once every 5 page impressions, which results in a higher average yield of $0.02 per page impression. Thus, it should be appreciated that any manner of quantifying offers, offer performance or the like may be included in the yield determination.

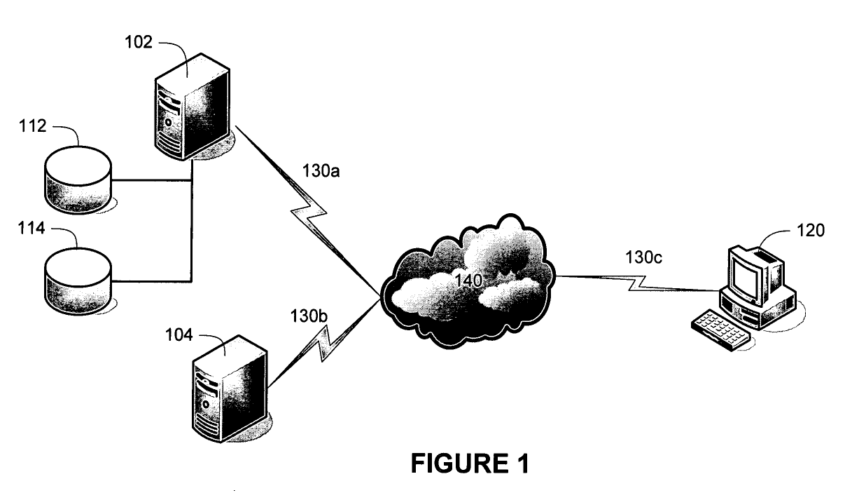

Referring now to FIG. 1, an example environment is illustrated wherein offers are electronically presented to a consumer. In addition to describing one such environment, FIG. 1 serves to demonstrate an example relationship between an advertiser, a presenter and a consumer. Presentation server 102 represents a computing device that either provides offer information to partner server 104, or hosts a web site or other electronic interface on which an offer may be presented. Presentation server 102 may be any type of computing device, such as for example a server, desktop or laptop computer or the like. Presentation server 102 has access to database 112 that contains characteristic information about one or more consumers, as well as data store 114 that contains offers for presentation. It will be appreciated that database 112 and data store 114 may be contained within presentation server 102, or may be accessible to presentation server 102 in another location.

The characteristic information may be received from the consumer by way of consumer computer 120 during a registration or login process at a partner electronic interface, such as a web site or the like. Alternatively, the characteristic information may be received by a third party or the like. As may be appreciated, an “electronic interface” may be any means by which a consumer may interact with an offer and/or a central server. A web site, each web page on a web site, Instant Messaging (IM) applications, Personal Digital Assistants (PDAs), telephones, desktop applications, streaming data applications and the like are all examples of an electronic interface, and all are equally compatible with an embodiment of the present invention. Although the description contained herein predominantly refers to web sites and web pages for purposes of clarity and explanation, it will be appreciated that an embodiment of the present invention is equally applicable to other forms of electronic interfaces.

The partner web site—or other type of electronic interface—is affiliated with a partner entity such as, for example, an e-commerce business and can be hosted by partner server 104. Presentation server 102 is able to communicate with consumer computer 120 and partner server 104. Such communication may be enabled by communications links 130a-c. Communications links 130a-c may be any means for conveying data, such as for example conventional cable, fiber optic cable, wireless or cellular transceivers and the like. In addition, communications links 130a-c may be connected by network 140. Network 140 may be, for example, a local area network (LAN), a wide area network (WAN), the Internet, an intranet or any other type of computing or electronic network.

The offer may be presented on behalf of any entity, such as the partner web site or an unrelated third party. Thus, in one embodiment a consumer visits the partner web site or other type of electronic interface and provides some type of information as requested by the web site as part of a registration process. If the consumer is already registered with the partner web site, the consumer may simply provide identifying information such as a password, email address, or may automatically be identified by way of a previously-set “cookie,” a unique identifier sent by the partner web site, or the like. The server that is hosting the partner web site—or partner-branded web site—transmits the information to partner server 102, which then uses the information to identify the consumer. As noted above, in some embodiments the server hosting the partner-branded web site may in fact be presentation server 102, so therefore the above-noted transmission of information may not be necessary. As will be discussed below, many computer and/or network configurations are consistent with an embodiment of the present invention.

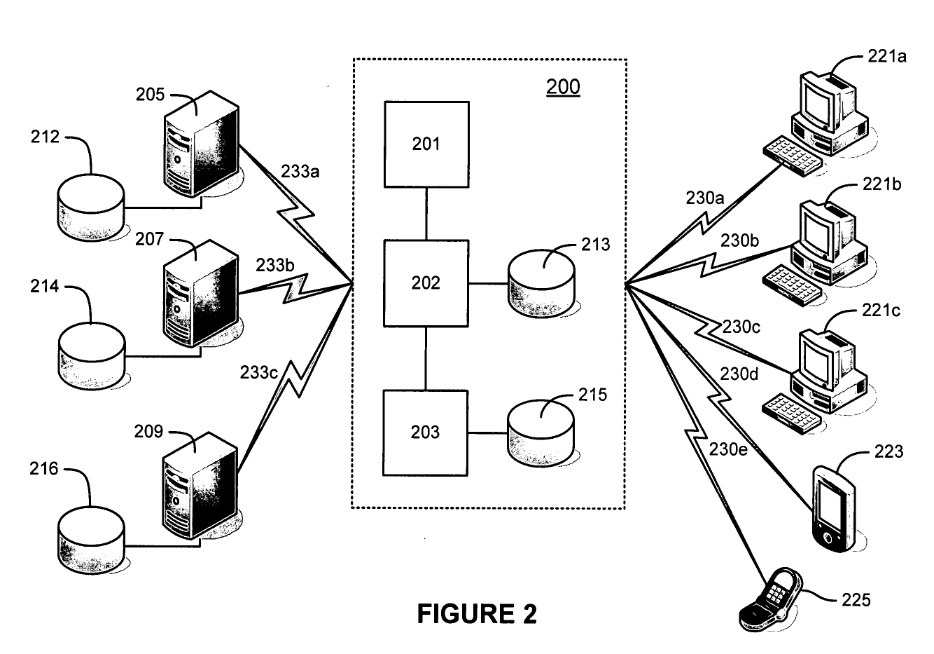

Now that an example computing environment for presenting offers to consumers has been described, an embodiment of the invention will be described in connection with FIG. 2. FIG. 2 illustrates the components that may be present in an embodiment for tailoring offers to consumers in a manner that maximizes the yield to a presenter and/or an advertiser.

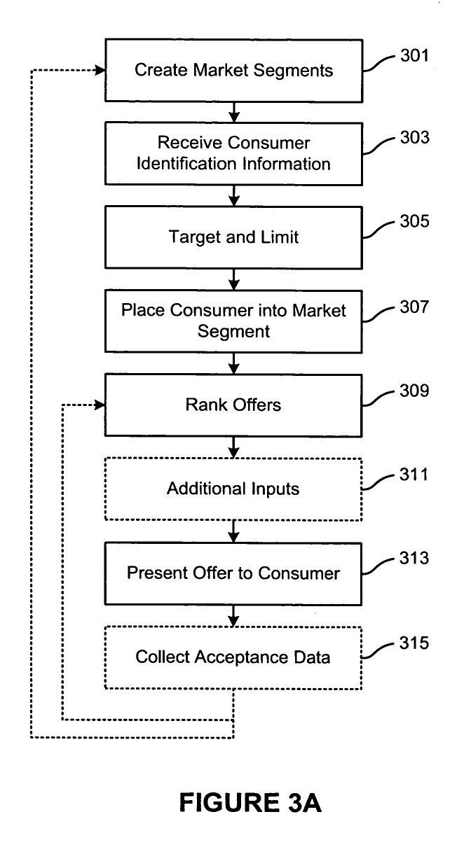

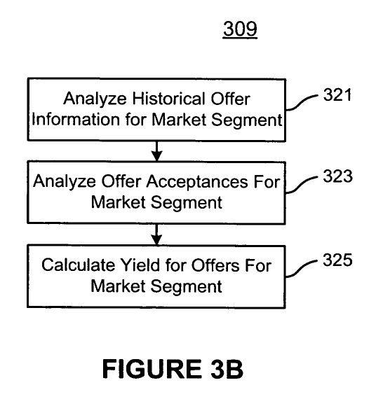

In the description of FIG. 2, the word “process” as used herein is intended to be a general description of any device or method that is capable of performing the functions of the process as described herein. Thus, a “process” may be any software or hardware module or component, software application, application program interface (API), electronic device, computer, server, computer-readable medium, or the like. For example, in one embodiment processes 201-203 are incorporated into a single application that performs the methods described below in connection with FIGS. 3A-B. In another embodiment, for example, the processes are performed by different computing devices. It will be appreciated that any configuration of computing software and/or hardware is equally consistent with an embodiment.

Offer process 200 comprises presentation process 201, yield determination process 202, market segmentation process 203, yield data 213 and consumer characteristics 215. Presentation process 201 provides functionality to present an offer to a consumer. The presentation of the offer may be by way of an electronic interface such as a web page or the like that is hosted by presentation process 201, or presentation process 201 may supply information to a device that is presenting an electronic interface to a consumer. Market segmentation process 203 uses consumer characteristics 215 to create one or more categories of consumers according to their characteristics. The market segmentation process 203 may use profiler data 216 that may be provided by profiler server 209. It will be appreciated that such profiled data 216 may be received by market segment process 203 by means that do not require profiler server 209. The profiler data 216 may be consumer data collected and/or analyzed by a third party or the like. For example, a profiler may provide external demographics which may include census information, national consumer and financial expenditure surveys alone or in combination with self-reported data and the like. Self-reported data may include product preferences and self-reported demographics as well as other information that describe the consumer. The segmentation process will be described in detail below in connection with FIGS. 3A-B.

Yield determination process 203, in an embodiment, uses yield data 213 for the segment in which a particular consumer has been placed. Historical data, such as for example an acceptance rate for the offer, may be included in the yield determination. Such historical data may, in one embodiment, be archival-type data of past offer performance or, in another embodiment, may be up-to-date information that may be updated on or near a real-time basis, for example. The yield determination, in one embodiment, may include the value of the offer to the presenter and/or the advertiser, the historical redemption rate within the consumer's market segment, and/or any other type of information. Yield can be maximized for the partner, presenter and/or the advertiser. In an alternate embodiment, the yield is optimized based on a revenue sharing formula between the parties. In either case an embodiment determines which offers are most likely to generate the maximum amount of revenue for the appropriate party. It will be appreciated that the yield determination may be used to maximize something other than revenue for the parties. For example, in one embodiment the yield determination may be used to maximize volume of offers redeemed, or any other parameter.

Partner server 205 may provide an electronic interface, such as for example a web page or the like, from which a consumer may be directed to a web page hosted by presentation process 201. A partner may be, for example, an offer aggregator that seeks out promotions on behalf of advertisers, or that combines sets of promotions from a variety of advertisers to create sets of promotional offers. Partner server 205 may alternately provide an electronic interface that receives offer information from presentation process 201. Partner server 205 may provide the electronic interface using partner data 212, which may include any type of information that is to be provided in the electronic interface. For example, partner data 212 may include information relating to products or services available via the electronic interface, etc. In one embodiment, presentation process 201 may aggregate offers received from partner server 205, either by direct storage or storage of a reference (e.g., URL) to the offer. Advertisers and/or partners may also provide yield information to yield determination process 202 that, as discussed below, determines the offers that are most likely to produce the maximum yield.

Advertiser server 207 may provide advertiser data 214 to offer process 200. Advertiser data 214 may include offers to be presented by presentation process 201 or the like. It will be appreciated that offer process 200 may obtain offers to be presented from an advertiser via other means, such as for example receiving the offers offline.

Offer process 200, by way of presentation process 201, communicates with a consumer via an electronic device of the consumer. For example, FIG. 2 illustrates consumer computers 221a-c that may be used by one or more consumers. Consumer computers 221a-c may be any type of computing device, such as for example a desktop computer, laptop computer or any other type of computer. In addition, the electronic devices that may be used to communicate with a consumer are not limited to computers. For example, FIG. 2 also illustrates a consumer device 223, which may be a personal digital assistant (PDA) or the like. Likewise, the consumer may receive offers by way of a cellular telephone 225. Thus, it will be appreciated that any type of electronic device may be used to present offers to a consumer, and any such device is consistent with an embodiment.

As was the case with communications links 130a-c described above in connection with FIG. 1, communications links 230a-e may be any means for conveying data, such as for example conventional cable, fiber optic cable, wireless or cellular transceivers and the like. In addition, communications links 230a-e may be connected by a network (not shown in FIG. 2 for clarity), such as described above in connection with network 140 of FIG. 1.

Turning now to FIG. 3A, a flowchart illustrating a method of performing market segmentation and yield management according to an embodiment of the invention is provided. It will be appreciated that any or all of steps 301-315 in FIG. 3A may be performed at or near a real-time basis. At step 301, one or more market segments are created. The creation of a market segment may incorporate a number of different parameters. For example, demographic, geographic, psychographic and other information may be included when creating a market segment. In one embodiment, a combination of consumer demographic information such as for example age and gender is combined with geographic information such as for example the consumer's ZIP code. In addition, offer acceptance and/or purchase history and other information may be included in the segmentation process. It will be appreciated that, in an embodiment, such market segments may be changed at any time. For example, the market segments may be changed based on the consumer acceptance data discussed below in connection with step 315, as indicated by the dashed arrow in FIG. 3A.

In one embodiment, a given market of consumers is divided into as many different segments as are necessary to represent a population of consumers in a statistically accurate manner. Thus, while it will be appreciated that a higher number of segments may improve the resulting offer targeting that takes place in step 305 because of the more detailed consumer analysis that would be required to segment a consumer population to a small level, diminishing returns may militate against excessive segmentation. In other words, the benefit to be gained from the more refined tailoring of offers may be offset by the complexity that results from a large number of market segments.

At step 303, consumer identification information is received. As was discussed above in connection with FIG. 1, a consumer may be identified by filling out a form, from a “cookie,” or the like. The consumer may, for example, enter the identification information on a partner server 207, a page hosted by presentation process 201, or the like. It will be appreciated that any type of consumer information may be received and used in the steps to follow. For example, if a consumer is using a PDA having a Global Positioning System (GPS) receiver, the consumer's location may be provided, so that offers for establishments or the like in the consumer's current geographic area may be ranked higher during the ranking of step 309. It can be seen, therefore, that any type of consumer data may be used in connection with an embodiment.

Once the consumer has been identified, at step 305 a preliminary targeting and limiting of offers is performed. In an embodiment, the targeting and limiting of offers of step 305 is performed using exclusionary rules that may eliminate certain consumers from the segmentation and ranking steps to be discussed below in connection with steps 307 and 309. Alternatively, the targeting and limiting of offers of step 305 may take place between or after steps 307 and 309. For example, an offer may only be available to female consumers, in which case all male consumers may be eliminated by step 305. Likewise, other criteria may be used to target offers, such as for example state of residence, credit rating and the like. As may be appreciated, the consumer data used to target and/or limit the consumers who may be presented with an offer may also be used in connection with, for example, market segmentation, offer ranking and/or yield management and the like.

At step 307, the now-identified consumer is placed into an appropriate market segment, based on whatever characteristics that may have been used when creating the market segment. Thus, for example, a married male consumer with two children who lives within ZIP code 19103 may be placed in a market segment for consumers with children in ZIP code 19103. It will be appreciated that a perfect match between consumer characteristics and the market segment characteristics may not be required by an embodiment. In addition, an embodiment may have a prioritization mechanism for placing a consumer in a market segment when multiple segments could be used. For example, using the above example consumer, a first market segment may be for male consumers who live within ZIP code 19103, while a second market segment may be for married consumers with two children. Such a prioritization mechanism could, for example, determine that a matching ZIP code between a consumer and a market segment has the highest priority, and therefore the consumer would be assigned to the first market segment. It will be appreciated that any number or combination of consumer characteristics may be used to prioritize the placement of a consumer into a market segment.

At step 309, the offers that may be presented to the consumer are ranked. The ranking of offers is discussed in detail below in connection with FIG. 3B. At optional step 311, additional inputs may be accepted. For example, the presenter, partner and/or advertiser may wish to override the offer ranking of step 309. Such a situation may arise, for example, when a new product is being promoted by a particular offer, and the advertiser wishes to increase consumer awareness of the product by presenting the offer to as many consumers as possible, regardless of the offer's place in the ranking of step 309. Other situations may involve the deletion of an offer, the addition of a discretionary offer, and the like. It will be appreciated more than one offer may ultimately be presented to a consumer, and one or more of such offers may have been ranked by way of step 309 and/or added or deleted by way of step 311.

At step 313, an offer is presented to a consumer. As noted above in connection with FIG. 2, the presentation of the offer may take place by way of any type of electronic interface and communications link such as, for example, a webpage, a text message, etc. Alternatively, the presentation of the offer may be made using a non-electronic mechanism such as, for example, printed media (e.g., flyers, billboards, direct mailing or other advertisements or solicitations). At optional step 315, acceptance data may be collected and incorporated into the offer ranking of step 309 and/or the market segment creation of step 301. The acceptance data may therefore be used to adjust the offer ranking to more accurately reflect the level of consumer interest in a particular offer. In an embodiment, such an adjustment may take place on or near a real-time basis. Thus, an offer that is receiving increased consumer interest, as indicated by increased acceptances of the offer, may be given a higher ranking. Likewise, an offer that is demonstrating lower consumer interest may be ranked lower. As may be appreciated, any of the ranking adjustments that may take place as a result of the acceptance data may be overridden in optional step 311, if desired. It will be appreciate that acceptance data need not be limited to the offer's acceptance rate. For example, the demographic, psychographic or other information of consumers who do or do not accept an offer may be used to further refine the ranking process.

As noted above, a detailed discussion of step 309 is provided in connection with FIG. 3B. Thus, and referring now to FIG. 3B, step 309 of FIG. 3A is represented as steps 321-325. At step 321, historical offer information is analyzed for the market segment to which the consumer to be presented with an offer has been assigned, as was discussed above in connection with step 307 of FIG. 3A. As noted above, “historical data” may be current data that may be updated at or near real-time, archival-type data or the like. At step 323, the offer acceptances for the market segment are analyzed. Such an analysis may incorporate any type of information regarding the market segment and/or individual consumers who have accepted offers in the past. In addition, in one embodiment the types and/or identities of offers may be incorporated into the analysis. Finally, at step 325, a yield for one or more available offers is calculated for the consumer's market segment. Thus, it will be appreciated that an embodiment may tailor an offer to be presented to a consumer based on the market segment to which the consumer has been assigned.

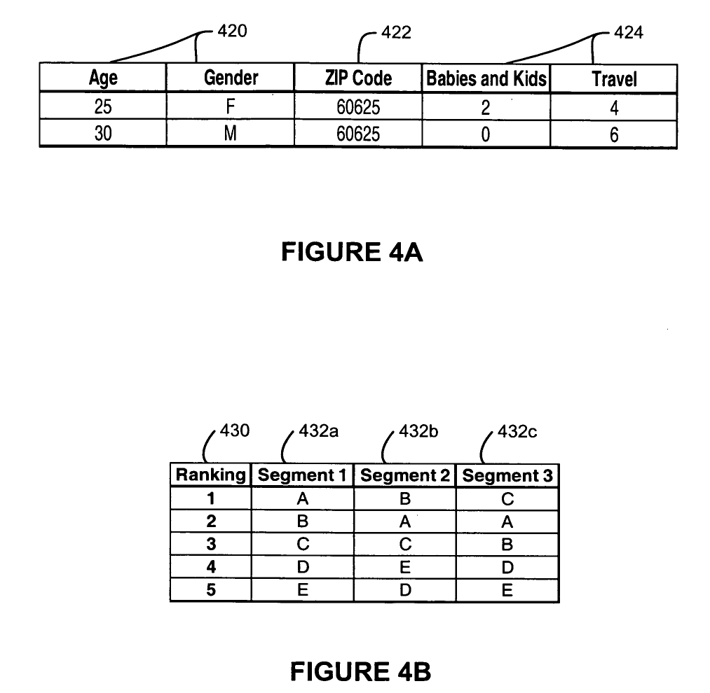

As noted above, in an embodiment, a consumer may be assigned to a market segment based on a variety of consumer characteristics. FIG. 4A is a diagram illustrating an example of consumer characteristics that may be used in connection with such an embodiment. For example, demographic data 420, such as for example the age and gender of a consumer as shown in FIG. 4A, may be used in determining a consumer's market segment. In addition, geographic data 422 such as for example the ZIP code in which the consumer resides may be incorporated into the market segmentation. Market activity 424 may also be incorporated into the market segmentation. For example, FIG. 4A illustrates market activity 424 as including the characteristics of “babies and kids” a consumer may have in his or her household, and “travel” as being an interest of the consumer, as indicated by a preference level.

As a result of the market segmentation that may take place using such information, the ranking of offers as discussed above in connection with FIGS. 3A-B may present different offers to different market segments, the same offers in a different order to different market segments, or the like. Thus, turning now to FIG. 4B, an example ranking of offers according to an embodiment of the invention is illustrated. Ranking 430 indicates the order, or priority or the like, of offers to be presented to a consumer. Thus, in FIG. 4B, a ranking of “1”indicates the highest-priority offer, “2” the second-highest, and so on. Segments 432a-c indicate three different example market segments. For purposes of the present discussion, the exact composition of characteristics for each segment is not relevant, rather, the fact that each segment is comprised of consumers having different characteristics is sufficient. Thus, it can be seen that in the embodiment illustrated in FIG. 4B provides offers A-E in a different order to each market segment as a result of the yield calculated for each offer with respect to the market segment to which it will be presented. As a result, it will be appreciated that an embodiment targets a particular market segment with offers that have the highest yield for that market segment.

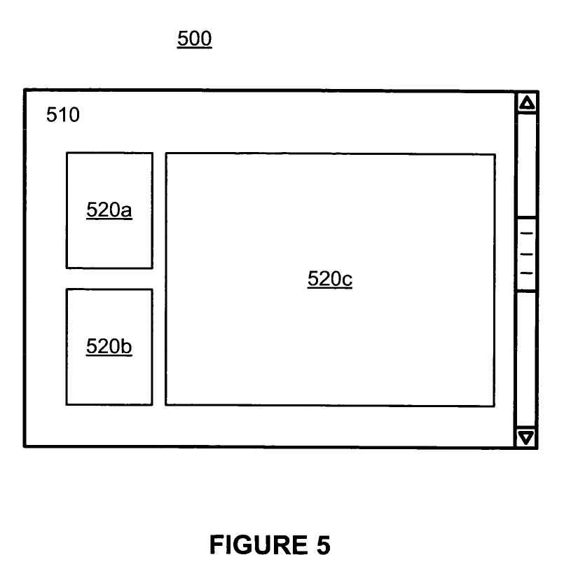

Now that the targeting and selection of offers for a consumer in a particular market segment has been discussed, FIG. 5 illustrates an example electronic interface in which an offer may be presented to a consumer. Electronic interface 500 of FIG. 5 comprises web page 510, although as noted above any type of electronic interface 500 is equally compatible with an embodiment. Within web page 510 are example locations 520a-c in which an offer may be presented. As illustrated in FIG. 5, location 520c may be a higher-priority location due to its size and location within web page 510. In contrast, locations 520a-b may be lower-priority locations due to their size and location within web page 510. Thus, it will be appreciated that an offer that is determined to have a higher yield for a given market segment may be presented to a consumer in a more prominent location, such as in location 520c, than an offer having a lower yield for the market segment. It will also be appreciated that an embodiment may be used in connection with other types of marketing methods. For example, additional colors, text, sounds, etc. may be used in connection with one or more higher-priority offers to entice a consumer to accept such an offer. Thus, it can be seen that any number of marketing and/or offer presentation techniques may be used in connection with an embodiment.

While the invention has been described in connection with the example embodiments of the various figures, it is to be understood that other similar embodiments may be used or modifications and additions may be made to the described embodiments for performing the same functions of the invention without deviating therefrom. Therefore, the present invention should not be limited to any single embodiment, but rather should be construed in breadth and scope in accordance with the appended claims.

What is claimed:

1. A method comprising:
creating a plurality of market segments;
assigning a consumer to one of the plurality of market segments based on at least one consumer characteristic;
determining a yield for each of a plurality of offers based on the assigned market segment; and
selecting one of the plurality of offers for presentation to the consumer based on its determined yield.

2. The method of claim 1, further comprising presenting the offer to the consumer.

3. The method of claim 2, further comprising ranking each of the plurality of offers based on the determined yield of each offer, and wherein said presenting is of the offer with the highest ranking.

4. The method of claim 3, wherein said selecting is of an offer that does not have the highest ranking.

5. The method of claim 1, wherein the offer is one of an advertisement, a form, a coupon or a solicitation.

6. The method of claim 1, wherein each of the plurality of market segments defines a different one of the at least one consumer characteristic, and wherein the at least one consumer characteristic is assigned by demographic or psychographic information.

7. The method of claim 1, wherein said assigning further comprises assigning the consumer to one of the plurality of market segments based on a plurality of consumer characteristics, wherein the consumer matches at least one of the plurality of consumer characteristics.

8. The method of claim 7, wherein said assigning further comprises ranking each of the plurality of consumer characteristics, and wherein said assigning further comprises assigning the consumer to a market segment defining a consumer characteristic having a highest ranking that is matched by the consumer.

9. The method of claim 1, wherein said determining is based on a prior acceptance rate for each of the plurality of offers from a plurality of consumers in the assigned market segment.

10. The method of claim 1, wherein said determined yield for each of the plurality of offers is based on a value to be received if the consumer accepts the offer.

11. The method of claim 1, wherein said creating, assigning, determining and selecting are performed on a real-time basis.

12. The method of claim 1, wherein said presenting comprises displaying the offer to the consumer on one of an electronic interface, direct mailing, text message and printed advertisement.

13. The method of claim 12, wherein the electronic interface is an email or webpage.

14. The method of claim 1, further comprising determining that the consumer accepts the offer.

15. The method of claim 14, wherein said determining of the yield is based on the consumer acceptance of the offer.

16. The method of claim 14, wherein said creating the plurality of market segments is based on the consumer acceptance of the offer.

17. The method of claim 1, further comprising determining whether the consumer is eligible for each of the plurality of offers based on the at least one consumer characteristic and wherein the selected offer is one of the plurality of offers for which the consumer has been determined to be eligible.

18. The method of claim 1, further comprising identifying the consumer and accessing profile data associated with the identified consumer.

19. The method of claim 18, wherein said assigning comprises comparing the profile data to the at least one consumer characteristic, and assigning the consumer to the market segment that most closely matches the profile data.

20. The method of claim 18, further comprising receiving a request to present the offer from a partner entity and sending the offer to the partner entity for presentation to the consumer.

21. The method of claim 18, wherein said accessing comprises requesting the profile data from a profiler entity and receiving the requested profile data.

22. The method of claim 18, further comprising receiving the plurality of offers from at least one advertiser entity, wherein the selected offer is associated with one of the at least one advertiser entities.

23. A computer readable medium having computer executable instructions for performing a method comprising:
creating a plurality of market segments;
assigning a consumer to one of the plurality of market segments based on at least one consumer characteristic;
determining a yield for each of a plurality of offers based on the assigned market segment; and
selecting one of the plurality of offers for presentation to the consumer based on its determined yield.

24. The computer readable medium of claim 23, wherein the method further comprises presenting the offer to the consumer.

25. The computer readable medium of claim 24, wherein the method further comprises ranking each of the plurality of offers based on the determined yield of each offer, and wherein said presenting is of the offer with the highest ranking.

26. The computer readable medium of claim 23, wherein each of the plurality of market segments defines a different one of the at least one consumer characteristic, and wherein the at least one consumer characteristic is assigned by demographic or psychographic information.

27. The computer readable medium of claim 23, wherein said determining is based on a prior acceptance rate for each of the plurality of offers from a plurality of consumers in the assigned market segment.

28. The computer readable medium of claim 23, wherein said determined yield for each of the plurality of offers is based on a value to be received if the consumer accepts the offer.

29. The computer readable medium of claim 23, wherein said creating, assigning, determining and selecting are performed on a real-time basis.

30. The computer readable medium of claim 23, wherein said presenting comprises displaying the offer to the consumer on an email or webpage.

31. The computer-readable medium of claim 23, wherein said presenting comprises displaying the offer to the consumer on one of an electronic interface, direct mailing, text message and printed advertisement.

32. The computer readable medium of claim 23, wherein the method further comprises determining that the consumer accepts the offer.

33. The computer readable medium of claim 32, wherein said determining of the yield is based on the consumer acceptance of the offer.

34. The computer readable medium of claim 32, wherein said creating the plurality of market segments is based on the consumer acceptance of the offer.

35. The computer readable medium of claim 23, wherein the method further comprises determining whether the consumer is eligible for each of the plurality of offers based on the at least one consumer characteristic and wherein the selected offer is one of the plurality of offers for which the consumer has been determined to be eligible.

36. The computer readable medium of claim 23, wherein the method further comprises identifying the consumer and accessing profile data associated with the identified consumer.

37. A system comprising:
a market segmentation process adapted to create a plurality of market segments and assign a consumer to one of the plurality of market segments based on at least one consumer characteristic;
a yield determination process in operative communication with the market segmentation process, wherein the yield determination process is adapted to determine a yield for each of a plurality of offers based on the assigned market segment; and
a presentation process in operative communication with the market segmentation and yield determination processes, wherein the presentation process is adapted to select one of the plurality of offers for presentation to the consumer based on its determined yield.
